(19) United States
(12) Patent Application Publication
(10) Pub. No.: US 2025/0309595 A1
(43) Pub. Date: Oct. 2, 2025

(54) THROUGH-WALL GENERATOR OUTLET AND RECEPTACLE KIT

(71) Applicant: Champion Power Equipment, Inc., Las Vegas, NV (US)

(72) Inventors: Greg Pauken, Hartland, WI (US); Chris Despears, Menomonee Falls, WI (US)

(21) Appl. No.: 19/090,720

(22) Filed: Mar. 26, 2025

Related U.S. Application Data
(60) Provisional application No. 63/570,862, filed on Mar. 28, 2024.

(51) Int. Cl. H01R 25/00; H01R 13/447; H01R 13/713; H01R 13/717; H01R 24/70; H01R 24/78; H01R 105/00; H01R 107/00; H02G 3/08; H02G 3/38

(52) U.S. Cl. CPC H01R 25/006; H01R 13/447; H01R 13/713; H01R 13/717; H01R 24/70; H01R 24/78; H02G 3/085; H02G 3/286; H01R 2105/00; H01R 2107/00; H01R 2201/10

(57) ABSTRACT

A through-wall generator outlet and receptacle kit may include a receptacle panel with a plurality of outlets configured for use on an interior side of a wall. A generator outlet box may be configured for use on an exterior side of the wall. A conduit stub, installed within a cavity in the wall, may be used to join the receptacle panel to the generator outlet box.

### CROSS-REFERENCE TO RELATED APPLICATION

The present application is a non-provisional of, and claims priority to, U.S. Provisional Patent Application Ser. No. 63/570,862, filed Mar. 28, 2024, the disclosure of which is incorporated herein by reference in its entirety.

### BACKGROUND OF THE INVENTION

Embodiments of the present invention relate to delivering electrical energy to the interior of a building from a generator. More particularly, the present invention is related to an apparatus and method of transferring electrical energy from a generator, through an exterior wall, and to the interior of the building.

Generator backup power has become more popular in recent times. With the addition of more and more products in the marketplace, it can be confusing for a homeowner to know what products are needed for different applications. Furthermore, the regulations and requirements of generator installation constantly evolve. Often times a homeowner may require a simple installation of a generator to power just a few items. Nevertheless, electrical contractor work is known to be expensive. Certifications, licenses, and general knowledge can take a long time to acquire.

Automatic transfer switches are a known solution for generator installations. They are used to automatically switch the building's circuit panel to backup generator power in the event of a power outage. Such solutions may be more than is needed or desired in certain situations.

For example, a homeowner may only require or want generator backup power for a single device inside the building. An automatic transfer switch would be much costlier and more difficult to install than a power outlet for the sole device. Running extension cords is commonly done, but it presents an unsightly tripping hazard. Furthermore, it can be very difficult to pass the extension cord from the exterior to the interior of the building. A door or window is typically always kept open for the cord, which is undesirable.

What is therefore needed is a convenient and safe way to provide electrical power to a single location of a building with a generator.

### BRIEF STATEMENT OF THE INVENTION

In accordance with one aspect of the invention, a through-wall generator outlet and receptacle kit may include a receptacle panel with a plurality of outlets configured for use on an interior side of a wall. A generator outlet box may be configured for use on an exterior side of the wall. A conduit stub, installed within a cavity in the wall, may be used to join the receptacle panel to the generator outlet box.

In accordance with another aspect of the invention, a through-wall generator outlet and receptacle kit may include a generator outlet box, attached to an exterior side of a wall. A male, locking blade plug on the generator outlet box may be used to connect a power generation device including one of a gasoline generator, a propane generator, and an inverter with a removable extension cord. An outlet cover attached to a hinge on the generator outlet box may be used to encapsulate the male, locking blade plug when it is unplugged. A receptacle panel may also be attached to an interior side of the wall. A plurality of outlets may be electrically connected to the locking blade plug on the generator outlet box through a hard-wired connection. A conduit stub may be used to facilitate the hard-wired connection joining the receptacle panel to the generator outlet box. The conduit stub may be within the wall.

In accordance with yet another aspect of the invention, a through-wall generator outlet and receptacle kit may include a generator outlet box, attached to an exterior side of a wall, with a male, locking blade plug configured for connection to a power generation device with a removable extension cord. An outlet cover attached to a hinge on the generator outlet box may be used to encapsulate the male, locking blade plug when not in use. A receptacle panel, attached to an interior side of the wall may include with a plurality of 120 volt outlets. Each one of the outlets may be electrically connected to the locking blade plug on the generator outlet box through a hard-wired connection. The receptacle panel may be fastened to the interior side of the wall with fasteners.

These and various other features and advantages of the present invention will be more readily understood from the following detailed description and the accompanying drawings.

### BRIEF DESCRIPTION OF THE DRAWINGS

The drawings illustrate embodiments presently contemplated for carrying out the invention.

In the drawings:

FIG. 1 is a sectional view of a wall showing the interior and exterior sides, and a through-wall generator outlet and receptacle kit installed, according to an embodiment of the invention.

FIG. 2 is a front view of only the receptacle panel, according to an embodiment of the invention.

FIG. 3 is a rear, perspective view of the receptacle panel, according to an embodiment of the invention.

FIG. 4 is a front, perspective view of only the generator outlet box, according to an embodiment of the invention.

FIG. 5 is a perspective view of installation parts used for the through-wall generator outlet and receptacle kit, according to an embodiment of the invention.

### DETAILED DESCRIPTION

Embodiments of the invention allow for safer and more convenient operation of a portable, power generation device. Such portable, power generation devices include gasoline generators, propane generators, diesel generators, inverters, and battery-powered power systems. The through-wall generator outlet and receptacle kit allows for all of these power generation devices to pass electrical power through a wall of a building in an improved manner. By installing the through-wall generator outlet and receptacle kit in an exterior wall of a building, there is no need to pass cords or wires through an open window, doorway, or the like. The through-wall generator outlet and receptacle kit provides a permanent location for a portable, power generation device to be connected to devices such as appliances within the building that may be hard-wired in the building.

One embodiment of the invention may be used on the exterior side of the wall. A generator outlet box may be used with a locking extension plug outlet such as a L14-30P configured to attached to a L14-30R outlet on the portable, power generation device with an appropriate extension cord. Other appropriate plugs may be used. One advantage that the invention provides is that a receptacle panel is hard-wired and affixed to the wall on an interior side of the building. This prevents accidental unplugging and eliminates the requirement of passing an extension cord through an open window or door. The receptacle panel also includes circuit breakers to protect any device and wiring should there be an electrical fault.

The operating environment of the invention is described with respect to a stationary or portable generator. However, it will be appreciated by those skilled in the art that the invention is equally applicable for use with any electrical power generating device. Moreover, the invention will be described with respect to a residential installation of a generator. However, one skilled in the art will further appreciate that the invention is equally applicable for use in any place where electrical energy is to be passed through a wall.

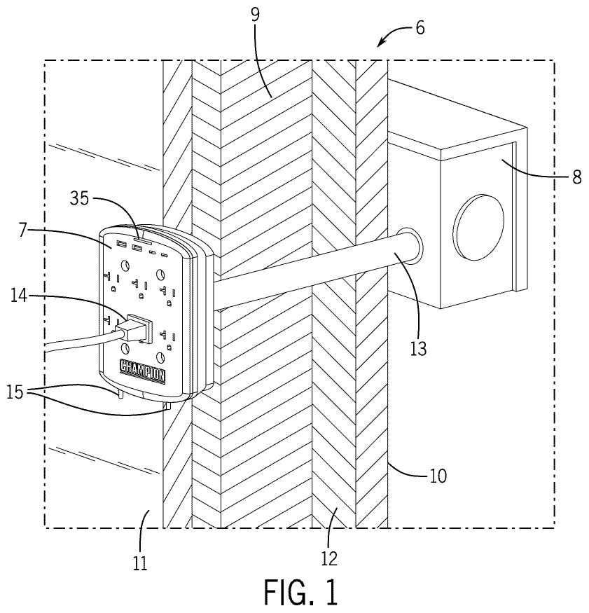

Referring to FIG. 1, a through-wall generator outlet and receptacle kit 6 is shown installed in an exterior wall cross section 9. A receptacle panel 7 may be mounted to the interior side 11 of the wall. On the exterior side 10, a generator outlet box 8 may be mounted. The receptacle panel 7 and the generator outlet box 8 are joined together by a conduit stub 13 which extends through the wall cavity 12. An electrical device may be connected to the receptacle panel 7 with a power cord 14. In order to protect the wiring and appliances that are plugged in to the receptacle panel 7, as well as any operators in the area, the receptacle panel 7 is equipped with circuit breakers 5. The circuit breakers 5 are preferably 20 amp breakers that are reset with a push-button. An indicator light 35 may also light up when the receptacle panel is live with electricity.

The generator outlet box 8 on the exterior side 10 of the wall is preferably constructed out of weather-proof materials. Preferably, a NEMA 3R enclosure rating is provided on the generator outlet box 8. A generator (not shown) is used to generate electrical energy. The generator may be electrically connected to the generator outlet box 8 with a removable, temporary power cord. This provides a degree of freedom when locating the proper place for the generator. Due to safety regulations, the generator may not be suitable for location in every area. By providing a generator outlet box 8, a flexible power cable can be used to connect the generator.

Electrical connections may be made inside of the generator outlet box so the electricity generated can be safely transferred within the building. The conduit stub 13 is used to protect the wiring as it passes through the wall cavity 12. On the interior side 11 of the wall the receptacle panel 7 may also be attached to the conduit stub, thereby keeping the wires concealed and protected.

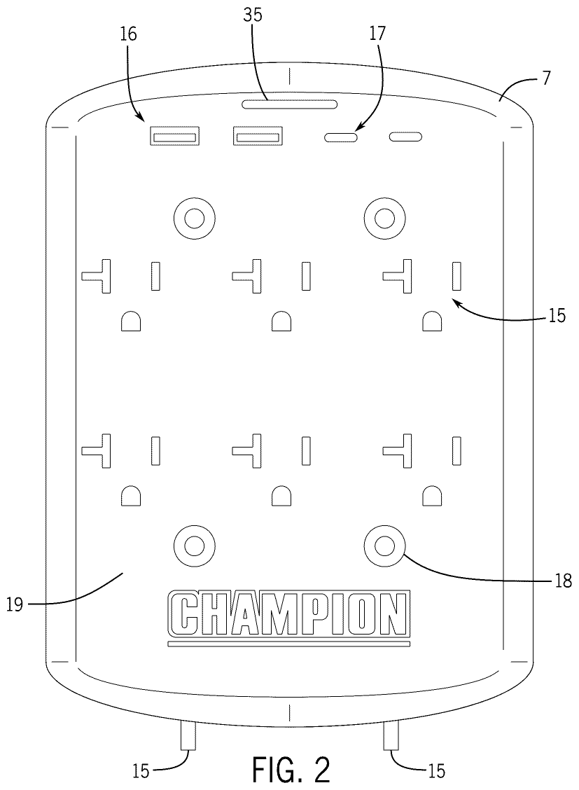

Looking to FIG. 2, the receptacle panel 7 is shown to include a plurality of 120 volt outlets 15. The circuit breakers 15 protect both the USB-A 16 sockets 16, the USB-C sockets 17, and the 120 volt outlets 15. The outlets 15 on the front 19 may be twenty amp outlets as shown, but there may be any configuration of outlets and types, depending on the application and applicable codes. In this embodiment, 120 volt outlets 15, USB-A sockets 16, and USB-C sockets 17 are provided. The power indicator 35 may also light up when the receptacle panel 7 is live with electricity and it may also change color should there be an electrical fault.

A series of fastener holes 18 may be used to seal the receptacle panel 7 closed. Preferably, the fastener holes 18 are spaced to allow the receptacle panel 7 to mount to a standard duplex outlet box in the wall cavity 12. However, any spacing may be provided to allow the receptacle panel 7 to be installed in a plurality of locations. The receptacle panel may also include a number of lights to indicate power availability status.

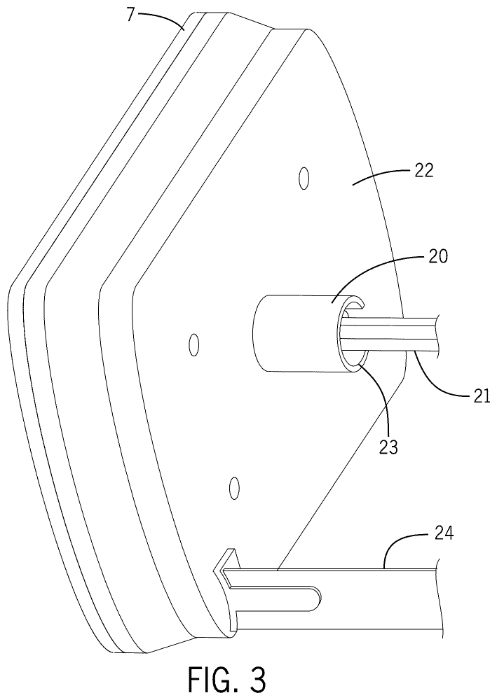

Transitioning to FIG. 3, the back 22 of the receptacle panel 7 is shown. A stub 20 extends from the back 22 of the receptacle panel 7 and provides access to the interior 23. Wiring 21 is shown extending from the interior 23 of the receptacle panel 7. The wiring 21 connects the 120 volt outlets 15, USB-A sockets 16, and USB-C sockets 17 as shown with respect to FIG. 2. The receptacle panel 7 may be provided pre-assembled with the wiring 21 already terminated within. This makes it easier for an installation expert to connect the device.

In a preferred embodiment, the stub 20 is already affixed to the back 22 of the receptacle panel 7 with the wiring 21 pre-terminated. A pigtail of sixteen inches may be provided allowing enough wiring to pass through the wall cavity 12. An installer simply needs to bore a hole in the interior side 11 of a wall and pass a conduit stub 13 through the wall cavity 12 and out of the exterior side 10 of the wall (see for example FIG. 1). This makes the installation of 120 volt outlets 15 simple and provides all the parts in a convenient kit. A tape measure 24 is also provided to indicate approximate sizing of the receptacle panel 7.

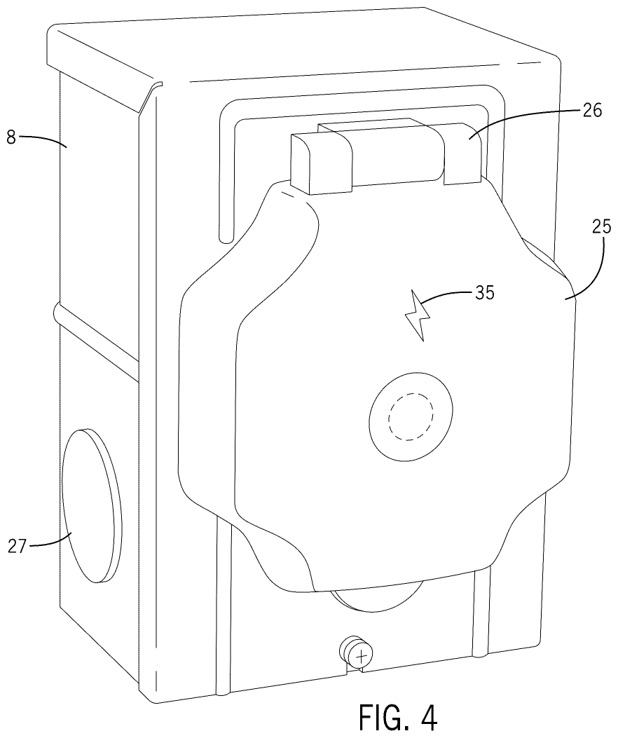

Referring now to FIG. 4, generator outlet box 8 is shown. An outlet cover 25 is provided to protect the wiring within the generator outlet box 8. A hinge 26 allows a user to rotate the outlet cover 25 to expose the outlet (not pictured). The outlet may be any kind of electrical outlet used to connect electrical generators. A knockout 27 is also shown in place, sealing the side of the generator outlet box, but as is known in the art, knockout 27 may be removed to provide additional options to the installer when making the electrical connection. Some additional options may include the orientation of the generator outlet box 8 to the exterior side 10 of the wall. Another power indicator 35 may be used to show that the generator outlet box is live with electricity by lighting up. The power indicator 35 may also change color should there be an electrical fault.

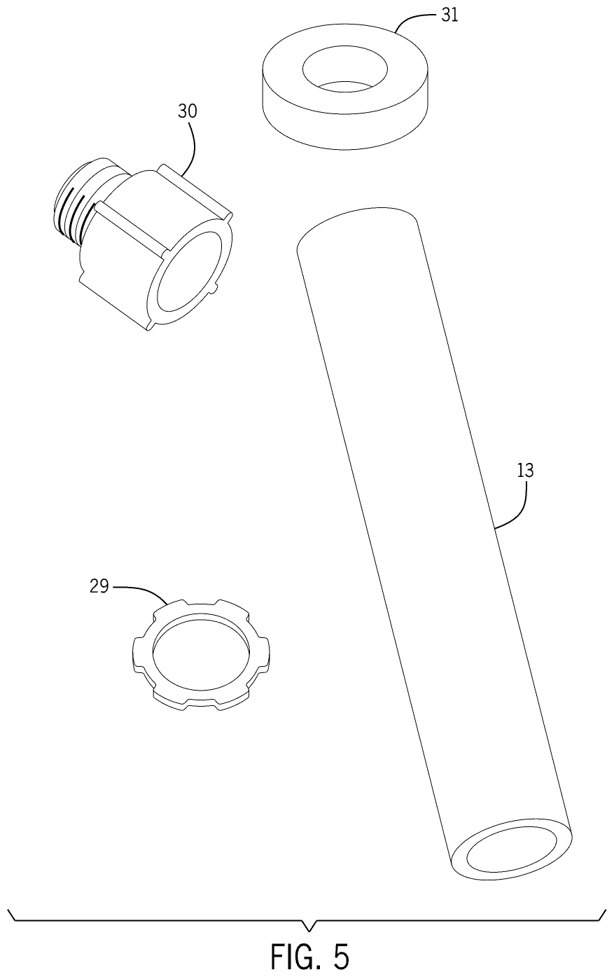

Moving on to FIG. 5, various installation accessories are shown that may be advantageous to an installer. The conduit stub 13 may be used in conjunction with a lock washer 29 and adapter 30. The lock washer 29 and adapter 30 are preferably used when connecting the conduit stub 13 to an outlet box when making the wiring connections of the receptacle panel 7. A donut gasket 31 may also be used when installing the generator outlet box 8 on the exterior side 10 of a wall, providing a lever of waterproofing around the installation hole. Any number of adapters 30, lock washers 29, and gaskets 31 may be used. Additionally, fasteners may be included for securing the generator outlet box 8 and receptacle panel 7 to the wall.

In accordance with one aspect of the invention, a through-wall generator outlet and receptacle kit 6 may include a receptacle panel 7 with a plurality of outlets 15 configured for use on an interior side 11 of a wall 9. A generator outlet box 8 may be configured for use on an exterior side 10 of the wall 9. A conduit stub 13, installed within a cavity 12 in the wall 9, may be used to join the receptacle panel 7 to the generator outlet box 8.

In accordance with another aspect of the invention, a through-wall generator outlet and receptacle kit 6 may include a generator outlet box 8, attached to an exterior side 10 of a wall 9. A male, locking blade plug 35 on the generator outlet box 8 may be used to connect a power generation device including one of a gasoline generator, a propane generator, and an inverter with a removable extension cord. An outlet cover 25 attached to a hinge 26 on the generator outlet box 8 may be used to encapsulate the male, locking blade plug 35 when it is unplugged. A receptacle panel 7 may also be attached to an interior side 11 of the wall 9. A plurality of outlets 15 may be electrically connected to the locking blade plug 35 on the generator outlet box 8 through a hard-wired connection. A conduit stub 13 may be used to facilitate the hard-wired connection joining the receptacle panel 7 to the generator outlet box 8. The conduit stub 13 may be located in a cavity 12 within the wall 9.

In accordance with yet another aspect of the invention, a through-wall generator outlet and receptacle kit 6 may include a generator outlet box 8, attached to an exterior side 10 of a wall 9, with a male, locking blade plug 35 configured for connection to a power generation device with a removable extension cord. An outlet cover 25 attached to a hinge 26 on the generator outlet box 8 may be used to encapsulate the male, locking blade plug 35 when not in use. A receptacle panel 7, attached to an interior side 11 of the wall 9 may include with a plurality of 120 volt outlets 15. Each one of the outlets 15 may be electrically connected to the locking blade plug 35 on the generator outlet box 8 through a hard-wired connection. The receptacle panel 7 may be fastened to the interior side 11 of the wall 9 with fasteners.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A through-wall generator outlet and receptacle kit comprising:
a receptacle panel with a plurality of outlets configured for use on an interior side of a wall;
a generator outlet box configured for use on an exterior side of the wall; and
a conduit stub joining the receptacle panel to the generator outlet box, configured for installation within a wall cavity.

2. The through-wall generator outlet and receptacle kit according to claim 1, further comprising at least one circuit braker on the receptacle panel electrically connected to the plurality of outlets and configured to disconnect an electrical connection between the receptacle panel and the generator outlet box when an electrical fault is detected by the circuit breaker.

3. The through-wall generator outlet and receptacle kit according to claim 1, wherein the generator outlet box includes a male, locking blade plug configured for transferring up to 30 amps.

4. The through-wall generator outlet and receptacle kit according to claim 3, further comprising an outlet cover attached to a hinge on the generator outlet box configured to encapsulate the male, locking blade plug when the male, locking blade plug is free of a mating plug.

5. The through-wall generator outlet and receptacle kit according to claim 3, wherein the receptacle panel is hardwired to the generator outlet box and is not unpluggable.

6. A through-wall generator outlet and receptacle kit comprising:
a generator outlet box, attached to an exterior side of a wall, with a male, locking blade plug configured for connection to a power generation device including one of a gasoline generator, a propane generator, and an inverter with a removable extension cord;
an outlet cover attached to a hinge on the generator outlet box configured to encapsulate the male, locking blade plug when the male, locking blade plug is free of a mating plug;
a receptacle panel, attached to an interior side of the wall, with a plurality of outlets electrically connected to the locking blade plug on the generator outlet box through a hard-wired connection; and
a conduit stub joining the receptacle panel to the generator outlet box, configured for installation within the wall.

7. The through-wall generator outlet and receptacle kit according to claim 6, further comprising at least one circuit braker on the receptacle panel electrically connected to the plurality of outlets and configured to disconnect an electrical connection between the receptacle panel and the generator outlet box when an electrical fault is detected by the circuit breaker.

8. The through-wall generator outlet and receptacle kit according to claim 7, wherein each one of the at least one circuit breaker is a 20 amp circuit breaker resettable with a push button.

9. The through-wall generator outlet and receptacle kit according to claim 6, wherein the plurality of outlets on the receptacle panel includes at least one 120 volt, alternating current outlet, at least one USB-A outlet, and at least one USB-C outlet.

10. The through-wall generator outlet and receptacle kit according to claim 6, further comprising a power indicator light on the receptacle panel configured to illuminate when the power generation device is supplying electrical power to the plurality of outlets.

11. The through-wall generator outlet and receptacle kit according to claim 6, further comprising a plurality of fastener holes in the receptacle panel configured for fastening the receptacle panel to the interior side of the wall.

12. The through-wall generator outlet and receptacle kit according to claim 6, wherein the male, locking blade plug on the generator outlet box is a 30 amp, 4-prong, locking, male plug.

13. The through-wall generator outlet and receptacle kit according to claim 6, wherein the receptacle panel is hardwired to the generator outlet box and is not unpluggable.

14. The through-wall generator outlet and receptacle kit according to claim 8, wherein the plurality of outlets on the receptacle panel includes at least one 120 volt, alternating current outlet, at least one USB-A outlet, and at least one USB-C outlet.

15. A through-wall generator outlet and receptacle kit comprising:
a generator outlet box, attached to an exterior side of a wall, with a male, locking blade plug configured for connection to a power generation device with a removable extension cord;
an outlet cover attached to a hinge on the generator outlet box configured to encapsulate the male, locking blade plug when the male, locking blade plug is free of a mating plug; and
a receptacle panel, attached to an interior side of the wall, with a plurality of 120 volt outlets, each electrically connected to the locking blade plug on the generator outlet box through a hard-wired connection, wherein the receptacle panel is fastened to the interior side of the wall with fasteners.

16. The through-wall generator outlet and receptacle kit according to claim 15, wherein the power generation device includes one of a gasoline generator, a propane generator, a diesel generator, an inverter, and a battery power station.

17. The through-wall generator outlet and receptacle kit according to claim 15, further comprising a conduit stub joining the receptacle panel to the generator outlet box, configured for installation within a cavity in the wall.

18. The through-wall generator outlet and receptacle kit according to claim 16, further comprising a power indicator light on the receptacle panel configured to illuminate when the power generation device is supplying electrical power to the plurality of outlets.

19. The through-wall generator outlet and receptacle kit according to claim 15, wherein the plurality of outlets on the receptacle panel further includes at least one USB-A outlet, and at least one USB-C outlet.

20. The through-wall generator outlet and receptacle kit according to claim 15, wherein the male, locking blade plug on the generator outlet box is a 30 amp, 4-prong, locking, male plug.
